(19) United States
(12) Patent Application Publication
(10) Pub. No.: US 2025/0348590 A1
(43) Pub. Date: Nov. 13, 2025

(54) QUANTITATIVE RESULT OF FAILURE AND MACHINE LEARNING MODELS

(71) Applicant: PAYPAL, INC., San Jose, CA (US)

(72) Inventor: Satyabrata Mishra, Bengaluru (IN)

(21) Appl. No.: 18/656,945

(22) Filed: May 7, 2024

(51) Int. Cl. G06F 21/57; G06N 20/00

(52) U.S. Cl. CPC G06F 21/577; G06F 2221/034; G06N 20/00

(57) ABSTRACT

A method includes receiving training data respective of a plurality of previous computing actions by a plurality of entities and training, based on the training data, a machine learning model to output a decision score. The training includes use of a loss function having input parameters including a percentage likelihood that a future computing action will fail, and a quantitative measure of a failed computing action. The method further includes receiving, from a user entity, a request for permission to engage in further computing actions, applying the trained machine learning model to data respective of the user entity to generate a decision score respective of the user entity, and rejecting, based on the decision score, the request for permission.

### TECHNICAL FIELD

This disclosure relates to machine learning improvements, including training of machine learning models that result in improved computer system performance.

### BACKGROUND

Certain computing actions may create additional future computing tasks requiring usage of power, processor time, memory, network bandwidth, and other computer system resources. For example, if a particular computing task includes making a decision (e.g. allowing the task to be performed or denying it), one outcome of the decision may result in future computing obligations.

### BRIEF DESCRIPTION OF THE DRAWINGS

FIG. 1 is a block diagram view of an example system for training and deploying a machine learning model for use in transaction permission evaluation.

FIG. 2 is a block diagram view of an example machine learning model.

FIG. 3 is a flow chart illustrating an example method of training and deploying a machine learning model for use in transaction permission evaluation.

FIG. 4 is a block diagram and flow chart illustrating an example method of training a machine learning model.

FIG. 5 is a flow chart illustrating an example method of performing computing transactions according to a machine learning evaluation.

FIG. 6 is a block diagram of an example computing system.

### DETAILED DESCRIPTION

A variety of conditional computing tasks (e.g. involving a decision) may obligate one or more computer systems to perform additional computing, utilizing computer system resources such as power, processor time, memory, and network bandwidth. In certain instances, an “incorrect” resolution to a conditional computing task may result in unnecessary additional future computing obligations. In such instances, using predictive machine learning models to more accurately assess and render a decision on the conditional computing task will prevent wastage of computer system resources (e.g. correctly deciding a greater number of conditional computing tasks will optimize and save computing resources).

Risk in computational transactions may be calculated according to a percentage or similar numerical risk that an attempted transaction will fail. Based on that calculated risk, a potential transaction may be evaluated to determine if it should be permitted or conducted. Such a risk evaluation may be improved by incorporating the expected value of the transaction into the calculations. By incorporating an expected value, the risk of failure of high-value transactions that may have a low absolute risk of failure may be properly assessed.

Risk evaluation according to the present disclosure may serve as a basis for permissions in computing transactions and determinations of whether to conduct such transactions, and what, if any, limitations to impose on such transactions. For example, in response to a user request for permission to engage in a particular type of computing action, a risk evaluation system may determine a risk associated with that particular user performing that type of computing action. The user's request may relate to the usage of resources controlled by the entity operating the systems and/or method of this disclosure. For example, a user may request access to a portion of a facility, and risk evaluation according to the present disclosure may be performed to determine whether or not to permit the user access, and/or limitations to place on that access. In another example, a user may request permission to exchange certain assets, and risk evaluation according to the present disclosure may be performed to determine whether or not to permit the user access to exchanges of such assets (or to permit a particular acquisition or other exchange), and/or limitations to place on that access. In yet another example, a user may request a line of credit for a particular transaction, and risk evaluation according to the present disclosure may be performed to determine whether or not to extend such credit to the user, and/or limitations to place on that credit.

Failed computing actions can create substantial burden to computing systems. For example, an attack on a secure system by a risky actor (that could have been denied access to the system in the first instance) can degrade a system's functionality, and can require substantial programming and computing execution hours to correct the degradation. Similarly, a user default on a high-value transaction (e.g., failing to perform a promised complex computing action in a multi-actor network) may require substantial computing resources for determining the source of the failure, providing the defaulted action from another source, etc. In another example, a user defaulting on a credit line may require substantial computing resources for addressing and ameliorating the default, including closing and reconciling accounts, coordinating notifications for affected users, and the like.

Accordingly, proper risk evaluation in high-value computing actions can reduce the negative impact on and improve performance of the involved computing systems. Further, risk evaluation according to the present disclosure may result in more frequent rejections or denials of high-value computing actions, thus inherently reducing the load or burden on the involved computing systems (by virtue of processing fewer computing actions in the first instance).

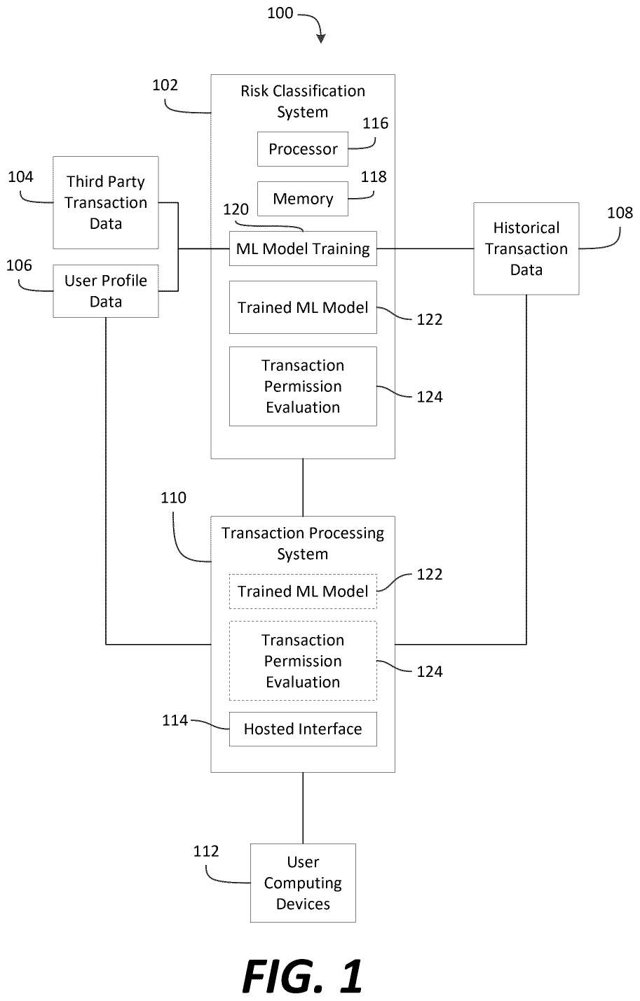

Turning to the figures, in which like numerals refer to the same or similar features in the various views, FIG. 1 is a block diagram view of an example system 100 for training and deploying a machine learning model for use in permission evaluation for computing actions, such as transactions. The system 100 may include a risk classification system 102, a source of third party transaction data 104, a source of user profile data 106, a source of historical transaction data 108, and a transaction processing system 110 that may communicate with one or more (e.g., a plurality of) user computing devices 112.

The transaction processing system 110 may be associated with (e.g., may host) a particular electronic user interface 114 and/or platform through which users (which may include individual users, merchants, etc.) perform electronic transactions (e.g., any of merchant-to-user transactions, user-to-user transactions, and merchant-to-merchant or other business-to-business transactions). The electronic user interface 114 may be embodied in a website, mobile application, etc. According, the transaction processing system 110 may be associated with or wholly or partially embodied in one or more servers, which server(s) may host the interface 114, and through which the user computing devices 112 may access the user interface.

The instant disclosure will make reference to transactions between entities. Transactions are used herein as an example type of computing action in which permissions are relevant. The instant disclosure may also find use with many other types of computing actions, such as access to secured systems or locations, trusted computing processes (e.g., blockchain storage, key-based encryption, etc.), and the like. In embodiments involving computing actions other than transactions, the transaction processing system may instead be another processing system with which users interact to instruct computing actions involving permissions.

The historical transaction data 108 may include records of a plurality of previous transactions (or other computing actions) performed through the transaction processing system 110. The records may include, for each transaction, one or more users involved in the transaction and one or more characteristics of the transaction. The characteristics of the transaction may include, for example, dates, values, a subject of the transaction (e.g., asset access or exchanged), and so on. The transactions may include the use (e.g., exchange) of resources controlled by each user. Accordingly, a given user may have one or more associated transactions stored in the historical transaction data 108.

The third party transaction data 104 may, like the historical transaction data 108, include records of a plurality of transactions, including one or more users involved in the transaction and one or more characteristics of the transaction. The third-party transaction data 104 may include, however, transactions performed other than through the transaction processing system 110 (e.g., transactions that were not processed by the transaction processing system 110). The third-party transaction data 104 may include, for example, credit bureau data or data from another third party source that tracks transactions or other computing actions by various users and entities.

The user profile data 106 may include user profiles for a plurality of users of the transaction processing system 110. A user profile may include, for example, a user's bibliographic information, location information, transaction history, and the like.

The risk classification system 102 may include a processor 116 and a non-transitory, computer-readable memory 118 that, when executed by the processor 116, cause the risk classification system 102 to perform one or more processes, operations, methods, algorithms, etc. of this disclosure. The risk classification system 102 may include one or more functional modules 120, 122, 124. Specifically, the risk classification system 102 may include a machine learning model training module 120, a trained machine learning module deployment module 122, and a transaction permission evaluation module 124. Each module 120, 122, 124 may be embodied in hardware and/or software (e.g., as instructions in the memory 118).

The machine learning model training module 120 may be configured to receive an untrained or partially trained machine learning model and to train the model to classify or quantify a risk associated with an input user and an input transaction or other computing action. The model may be, for example, a neural network or other model type that may be used for making predictions (e.g., labels or classifications) based on various input parameters/data, which predictions may be further used for decision making. In some contexts, the training module 120 may train a neural network for use in financial-related, risk-related and/or other decisions related to granting users permission to engage in computing actions, including but not limited to credit applications, fraud detection, site access, shared resource access, etc.

In some embodiments, the training module 120 may train a machine learning model, such as a linear regression based binary classification model, neural network, or other model, to predict a classification/label, namely a probability of a failed computing action (e.g., default) at a given future time frame (e.g., at 18 months or any future time frame) or other risk score (as used herein, a “risk score” may also be referred to as a “decision score,” according to various embodiments). This model may use various input parameters or variables. For instance, for a target user, the input features may include target user data of the target user that is available from one or more sources (e.g., the historical transaction data, the third party transaction data, the user profile data, etc.). This target user data may correspond to short term user data indicative of short term risk factors, such as time (e.g., months, weeks, days, years, etc.) from opening a most recent account, a number of new accounts in a time frame (e.g., last 12 months or any other appropriate period of time), a number of revolving accounts with a certain (e.g., 75% or any other appropriate percent) utilization rate, and/or other balances. The target user data may also correspond to long term user data indicative of long term risk factors, such as a number of months of delinquency (e.g., 3 or more months or any other number of months), a number of months since a last default, a ratio of transaction declines in a time frame (e.g., last 12 months or any other appropriate period of time), a number of months since a 1 month delinquency (e.g., for live accounts), etc. Where used for risk classification in other contexts (e.g., shared computing access, site access), the target user data may include the user's history of access to other sites or other shared resources, first-order, second-order, and/or greater-order connections of the users to known suspicious entities (or the reputations of connected entities to the user), a quantity of sites or shared computing resources to which the user already has access, and the like. The input features to the model may also include a quantitative value of a failed transaction, in some embodiments, such as a quantity of default, value of shared computing resources, value of goods at a site, etc.

The model may be trained to predict, from the input features, a probability of default or other adverse outcome at the future time frame for the target user, which may further be used to place the target user in a risk quantile (e.g., decile, percentile, etc.). Risk quantiles considered low risk may be considered for credit approval or approval for another transaction or computing action. Moreover, within the approved quantiles, a credit line determination (e.g., between a high credit line and a low credit line) may be based on the risk quantile, with lower risk quantiles being recommended for higher credit lines. In some examples, users (e.g., borrowers seeking credit) may be categorized into the risk quantiles or risk score bands based on users' credit risk profiles. The risk quantiles may be used for allocation of credit limits and/or interest rates. For instance, users with lower assessed risk (e.g., categorized into a low risk quantile) may receive higher credit limits and lower interest rates, whereas higher-risk users (e.g., categorized into a higher risk quantile) may receive lower credit limits and/or higher interest rates. Alternatively, for other types of computing actions, other quantitative restrictions or requirements may be imposed, such as computing or monetary collateral, time-based access or usage restrictions, and the like. In addition, regular reviews and adjustments of credit lines may be conducted to align with changes in borrower risk profiles. Accordingly, using risk quantiles may allow responsible lending, regulatory compliance, and risk management, which may further foster transparency and fairness in a lending process.

Although binary classification allows efficient predictions that may be used for credit decisions, being limited to a single future time period may not allow for changes in risk over time for users. For example, a given user may default early (e.g., at 6 months) and later (e.g., at 12 or 18 months) remain in default or cure the default, or alternatively may not default early, but default later. More generally, a risk of a failed computing action for a particular user may increase or decrease over time, and a single time-point classification may not best categorize that shifting risk. In other words, using the binary classification may limit risk strategies as users that may change default risk (e.g., users that would cure default) may be treated as if no changes are expected over time. For more flexible strategies, multiple time periods may be considered. However, having a separate binary classification model for each desired time period may become cost and resource prohibitive, as well as may require managing which data is input into which model.

Accordingly, a multi-label neural network may be trained to classify multiple labels corresponding to multiple time periods, allowing use of a single model rather than multiple models. The single model may learn multiple behaviors rather than requiring a separate model for each behavior. More specifically, the single model may learn multiple risk probabilities over multiple future time periods from tabular input data (e.g., that may be normalized). Evaluating a user's risk probabilities over multiple time periods allows for more nuanced and robust analysis of risk. For instance, predicting risk at a single time period (such as from a binary classification model described above) may limit analysis to a simple probability without allowing analysis of how the probability may change over time. In other words, when analyzing risk at the single time period, a user having a risk that could be predicted to rise over time and another user having a risk that could be predicted to fall over time could have a same risk probability at the single time period. Without the additional analysis over multiple time periods, these two users could be labelled the same despite divergent potential outcomes over time.

The machine learning model may be trained to provide numerous outputs related to risk. For example, the model may be trained to output a degree of risk of a negative event. In an embodiment in which the model is deployed to determine a risk of credit default, the model may output a percentage (or similar measurement) of a default event occurring (referred to herein as a “negative event risk”). Additionally or alternatively, the model may output an overall risk score that accounts for both the negative event risk and the quantity of loss if a negative event occurs (referred to herein as a “quantitative risk”). Accounting for both the negative event risk and the quantitative risk may better enable evaluation of computing actions with a high quantitative risk, i.e., may enable consideration of whether a user is more likely to have a failed computing action on a high value action than on a low value action, or to require a higher degree of trustworthiness from users for high quantitative value actions than for low quantitative value actions.

The deployed trained machine learning model 122 may receive, as input, information about a user and about a requested computing action and may output, in response, a risk classification, such as one or more risk scores for one or more time periods. The trained machine learning model 122 may be deployed in the risk classification system 102 and/or in the transaction processing system 110, in various embodiments.

The transaction permission evaluation module 124 may receive a computing action permission request, retrieve any necessary data for evaluation of that request, interact with the deployed machine learning model 122 to determine a risk classification of the user/computing action combination, determine whether to permit or deny the user's requested computing action, and determine appropriate limitations on the permission decision. For example, the transaction permission evaluation module 124 may retrieve relevant data from the historical transaction data 108, the third party transaction data 104, and/or the user profile data 106, input that data and requested computing action to the deployed machine learning model 122, and receive a risk classification from the machine learning model output. Based on the risk classification, the transaction permission evaluation module 124 may grant or deny permission to the user to perform the requested computing action. If permission is granted, the transaction permission evaluation module 124 may determine certain conditions on the permission and convey those conditions to the user. For example, the conditions may include a limitation on the scope of the computing action, one or more future actions that must be performed by the user after the computing action, and the like. The transaction permission evaluation module 124 may be deployed in the risk classification system 102 and/or in the transaction processing system 110, in various embodiments.

In some embodiments, the deployed trained machine learning model 122 and the transaction permission evaluation module 124 may be provided in different computing resources. For example, the transaction permission evaluation module 124 may be provided in the transaction processing system 110, and the deployed trained machine learning model 122 may be provided in the risk classification system 102, or vice-versa.

In some embodiments, the risk classification system 102 (e.g., the functionality thereof) may be deployed in order to determine whether or not to extend credit to users. In such embodiments, a user's requested computing action may be the request for credit (e.g., a request to perform a certain transaction on credit). In such embodiments, the deployed machine learning model 122 may receive information about the user and the requested amount of credit and output a risk associated with extending the credit to the user. The risk may represent, for example, a risk that the user will default on the credit. The transaction permission evaluation module 124 may utilize the output of the deployed machine learning model 122 to grant or deny the request for credit. Where credit is granted, the transaction permission evaluation module 124 may determine conditions on that credit based on the output of the deployed machine learning model 122, such as an amount of credit to grant, payment conditions, and the like.

In other embodiments, the risk classification system 102 may be deployed in order to determine whether or not to grant access to a common computing service to users. In such embodiments, a user's requested computing action may be a request to use a certain volume of computing resources, or a request to perform a certain series of computations using the common computing service. In such an embodiment, the deployed machine learning model 122 may receive information about the user and the requested quantity or type of computing resources and output a risk associated with permitting the user access to the requested computing resources. The risk may represent, for example, a risk that the user may perform unauthorized operations with the shared computing resources (e.g., illegal activity, for example), a risk that the user may upload malicious code to the shared computing resources, or some other risk. The transaction permission evaluation module 124 may utilize the output of the deployed machine learning model 122 to grant or deny the request for the user to use the common computing service. Where permission is granted, the transaction permission evaluation module 124 may determine conditions on that the user's access based on the output of the deployed machine learning model 122, such as a quantity of shared computing resources that the user will be permitted to use, a specific set of computing resources that the user will be permitted to use (e.g., specific servers), conditions on the user's access to the shared computing resource (e.g., periodic use audits, collateral requirements, etc.), and the like.

In other embodiments, the risk classification system 102 may be deployed in order to determine whether or not to grant access to a physical site (e.g., a facility, specific computing hardware, etc.) to users. In such embodiments, a user's requested computing action may be a request to access the site (e.g., presentation of a credential by the user at a secure access scanner), or to be authorized to access the site. In such an embodiment, the deployed machine learning model 122 may receive information about the user and the site (e.g., the value of hardware at the site, or downside value of potential illicit activity at the site) and output a risk associated with permitting the user access to the requested site. The risk may represent, for example, a risk of theft associated with the user, a risk that the user will damage the site or some portion of the site, or some other risk. The transaction permission evaluation module 124 may utilize the output of the deployed machine learning model 122 to grant or deny the request for the user to access the site. Where permission is granted, the transaction permission evaluation module 124 may determine conditions on that the user's access based on the output of the deployed machine learning model 122, such as portions of the site to which the user will be granted access, days or times of day on which the user will be granted access, conditions on the user's access to the site (e.g., periodic access and resource use audits, collateral requirements, etc.), and the like.

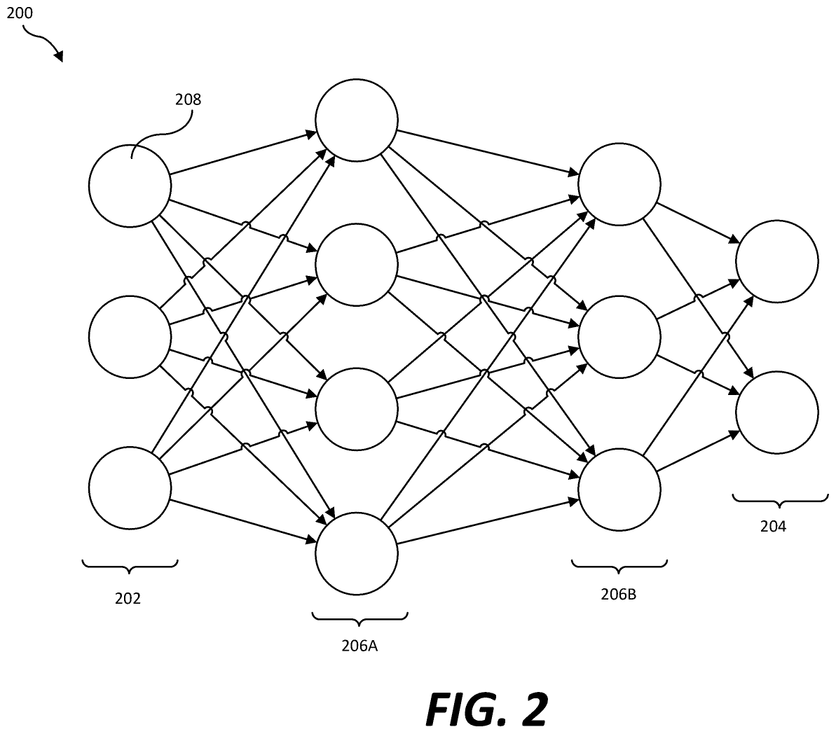

FIG. 2 is a block diagram view of an example machine learning model 200. The example machine learning model 200 may be a neural network that may include an input layer 202, an output layer 204, and multiple hidden layers (e.g., a hidden layer 206A, a hidden layer 206B) interconnected therebetween. Each layer (e.g., input layer 202, hidden layers 206A, 206B, and/or output layer 204) may include various iterations of a node 208.

Each node 208 may act as its own linear regression model having input data, weights, biases/thresholds, and outputs. Each node 208 may apply appropriate weights and biases, and if the result satisfies an activation threshold (which may correspond to a node in a next layer) the result may be sent as an input to the corresponding node in the next layer. As illustrated in FIG. 2, each node 208 may be fully interconnected with every node in the next layer. Based on corresponding activation thresholds, a given node 208 may send its result to the corresponding next node. Thus, input features may be input into input layer 204 (e.g., each feature or value corresponding to each node 208 in input layer 202) which when processed through hidden layer 206A and hidden layer 206B, may be output to output layer 204. Although FIG. 2 illustrates a simplified example, in other examples neural network 200 may include additional layers, nodes, connections, etc.

Each node 208 of output layer 204 may correspond to a different label/classification. In FIG. 2, neural network 200 is a multi-label neural network for two labels, although in other examples more labels may be included. In some examples, a label value may be a probability (e.g., from 0 to 1) that the label applies although in other examples, a label value may be true/false (e.g., 0/1) that the label applies. In some embodiments, one label value may be a percentage probability of a negative computing action, and another label may be a risk score that accounts for both percentage risk and quantitative value of loss.

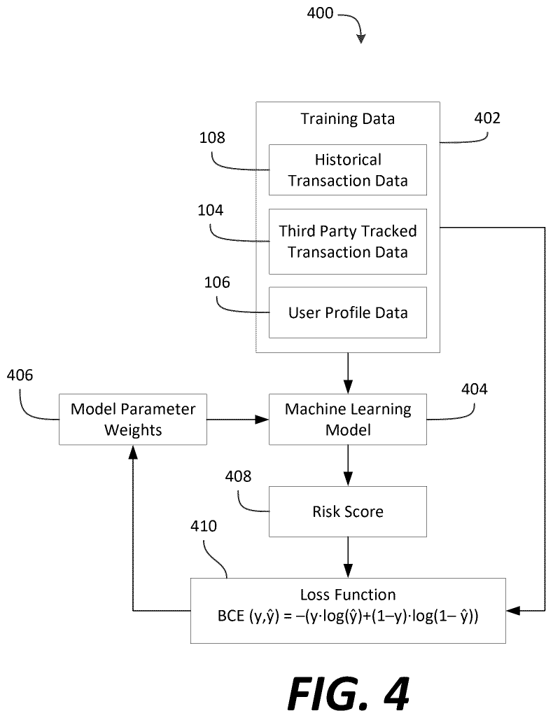

The weights, biases, and/or thresholds may be determined through training. For instance, a training data set may include input values associated with desired output labels. The training data set may be input into neural network 200, the resulting output compared to the desired output, and an error (between the resulting output and the desired output) backpropagated through neural network 200 to update weights, biases, thresholds, etc. as needed (as described herein with respect to FIG. 4). In some examples, one or more hidden layers (e.g., hidden layer 206A and/or hidden layer 206B) may act as feature detection layers or otherwise be normalization layers. Feature detection layers may include nodes that may combine inputs to convert raw data inputs from input layer 204 into values that are mathematically and/or computationally easier to process. Normalization layers may include nodes for scaling inputs into ranges that may also be mathematically and/or computationally easier to process. The feature detection layers and/or normalization layers may include weights and biases that correspond to features or other statistical relationships between certain input nodes that may be developed during training.

When establishing a multi-label neural network for tabular data such as financial data and/or other user data, the multi-label neural network may be more efficiently configured, as will be described further below. With tabular data, such as financial data and/or other user data, each of the input features may already be formatted such that feature detection may not be needed. Moreover, tabular data may be readily preprocessed to normalize values. Accordingly, the multi-label neural network for tabular data may not require feature detection and/or normalization layers.

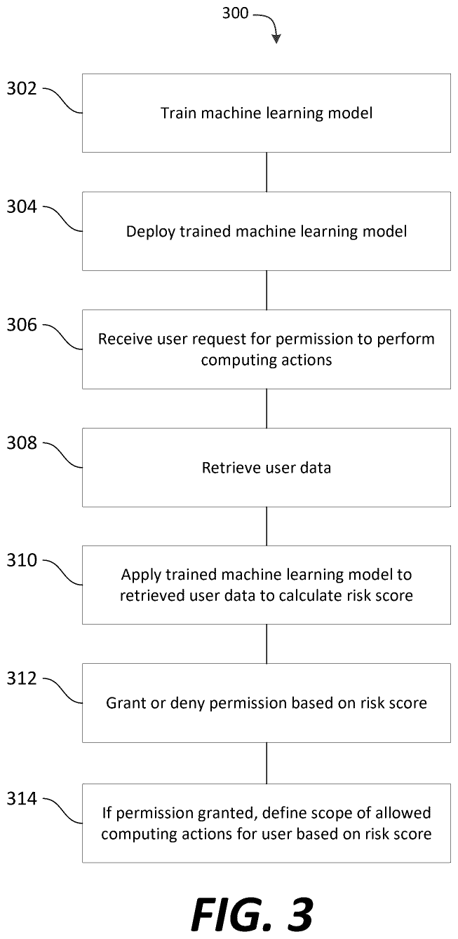

FIG. 3 is a flow chart illustrating an example method of training and deploying a machine learning model for use in transaction permission evaluation. The method 300, or one or more aspects of the method 300, may be performed by the risk classification system 102 and/or the transaction processing system 110.

The method 300 may include, at block 302, training a machine learning model. Block 302 may include operations described with respect to FIG. 4 and above with respect to FIGS. 1 and 2, in some embodiments.

The method 300 may further include, at block 304, deploying the trained machine learning model. The trained machine learning model may be deployed in a dedicated support system or resource (e.g., the risk classification system of FIG. 1, where the risk classification system is provided as a separate system), and/or in a system that will perform or facilitate the computing actions for which the machine learning model will evaluate risk. In other words, the trained machine learning model may be deployed on-premises for a particular purpose, or may be offered and accessed on a third party service basis.

The method 300 may further include, at block 306, receiving a user request for permission to perform a computing action. The request may be for the user to use resources controlled by or on behalf of an entity performing the method 300 (e.g., monetary resources, such as a credit line, or computing resources, such as a shared computing service). The user request may be, for example, a user request through a transaction processing system to obtain credit from or through the transaction processing system. Alternatively, the user request may be a request to access or utilized shared computing resources. Alternatively, the user request may be a request to access a site. Block 306 may include different user requests for permission to perform computing actions, as well.

The method 300 may further include, at block 308, retrieving user data. Block 308 may include retrieving historical transaction data respective of the system performing the method 300, or for which the method 300 is performed (e.g., the transaction processing system 110 of FIG. 1). Block 308 may also or instead include retrieving third party data (e.g., from a credit bureau) and/or user profile data, and/or user data from one or more other sources. The user data retrieved may include information related to transactions or other computing actions that used resources controlled by the user.

The method 300 may further include, at block 310, applying the trained machine learning model to the retrieved user data to calculate a risk score associated with the user and the requested computing action. Block 310 may include inputting the retrieved user data into the machine learning model. Block 310 may also include inputting information respective of the requested computing action into the machine learning model. For example, the quantitative value of the requested computing action may be input to the model, or another quantitative measure of the computing action. In response, the model may generate and output one or more measurements of risk, such as a percentage chance of an adverse event, a risk score that accounts for both the percentage chance and a quantitative measure of the computing action, or both. The model may generate and output the one or more measurements of risk for one or more time periods.

The method 300 may further include, at block 312, granting or denying permission to the user to perform the requested computing action based on the calculated risk score or other output of the model. Block 312 may include, for example, comparing the risk score or other output of the model to a threshold and, if the risk score is below the threshold, granting permission to the user in response to the user's request to perform a computing action. If the risk is above the threshold, block 312 may include denying permission to the user in response to the user's request to perform a computing action.

The method 300 may further include, at block 314, if permission was granted, defining a scope of permitted computing actions for the user based on the calculated risk score. For example, block 314 may include defining a maximum quantity of the requested computing action that is permitted (e.g., an amount of credit, a quantity of shared computing resources, a portion of a site to which access is granted). In another example, block 314 may include defining a reciprocal requirement from the user (e.g., a quantity of collateral, a payment schedule, etc.). In some embodiments, block 314 may include defining the scope of permitted computing actions according to a shift in risk score over time. For example, broader permissions, larger maximum quantities of actions, and/or lesser reciprocal requirements may be granted for a risk score that decreases over time, whereas risk score that increases over time may result in narrower permissions, smaller maximum quantities of actions, and/or greater reciprocal requirements.

In some embodiments, blocks 312 and 314 may include storing the user's permissions, permitted scope, and conditions on permissions for retrieval in connection with evaluating further user requests to perform the same or similar computing actions.

FIG. 4 is a block diagram and flow chart illustrating an example method 400 of training a machine learning model. The method 400, or one or more aspects of the method 400, may be performed by the risk classification system 102.

The method 400 may include inputting a set of training data 402, including historical transaction data 108, third-party transaction data 104, and user profile data 106, into a machine learning model 404, where the machine learning model 404 operates according to a set of parameter weights 406. The model 404 may be a multi-label neural network as described above, in some embodiments. The machine learning model 404 may output a risk score 408. To evaluate the accuracy of the model's prediction, the risk score 408 may be input to a loss function 410, along with the training data 402 and associated outcomes (e.g., which transactions resulted in a failed transaction, and the quantity of those failures). The loss function 410 may have the form of equation (1) below:

BCE(y,ŷ)=−(w·y·log(ŷ)+(1−y)·log(1−ŷ)) (Eq. 1)

where y is the training data outcome of a transaction (failed or successful), ŷ is the prediction of the machine learning model (e.g., a risk score), and w is a scaling factor based on the quantity of actual or potential loss associated with the transaction. In some embodiments, w may be calculated according to equation (2) below:

w=1+log(L)/10 (Eq. 2)

where L is the quantity of loss of the failed transaction, and equation (2) thus includes a calculation of a logarithm of that quantity of loss. Accordingly, the use of w in the loss function serves to scale the difference between the predicted and real data by the quantity of potential loss.

Based on the value of the loss function 410, the values of the parameter weights 408 may be adjusted, and the machine learning model 404 tested again with the training data 402. The values of the parameter weights 408 may be iteratively adjusted, and the model 404 tested, so as to minimize the loss function 410 until an acceptable loss function value is obtained. The trained model may then be deployed as described herein.

By training the machine learning model according to a quantity of potential loss and likelihood of failure, instead of only on a likelihood of failure, the model is better trained to evaluate potential losses that occur infrequently, but with large potential loss per failure. As a result, as noted above, the functioning of the computing systems for which risk is assessed is improved by virtue of fewer resources utilized on high-leverage computing actions, and/or fewer resource required to correct or otherwise address failed actions.

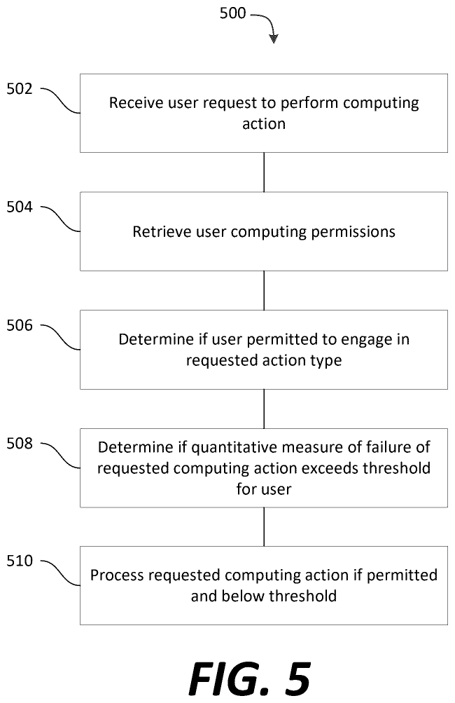

FIG. 5 is a flow chart illustrating an example method of performing computing transactions according to a machine learning evaluation. The method 500, or one or more aspects of the method 500, may be performed by the risk classification system 102 and/or the transaction processing system 110.

The method 500 may include, at block 502, receiving a user request to perform a computing action. Block 502 may be similar to block 302 of FIG. 3, for example.

The method 500 may further include, at block 504, retrieving one or more computing action permissions associated with the user and, at block 506, determining if the user is permitted to engage in the requested action according to the permissions. Blocks 504 and 506 may include comparing the requested computing action to a stored permissions set associated with the user to determine, on a Boolean basis, if the requested computing action is one for which the user has permission. For example, blocks 504 and 506 may include determining if a user has a credit line in response to the user requested to make a purchase on credit, or determining if a user has permission to access a shared computing resource in response to a request to use the shared computing resource, or if the user has permission to access a facility in response to the user entering a credential to access a portion of the facility.

The method 500 may further include, at block 508, determining if a quantitative measure of a failure of the requested computing action exceeds a threshold set for the user. For example, block 508 may include determining if the amount of requested credit exceeds the user's credit limit, or if the portion (e.g., specific server) or quantity (e.g., processing time) of the shared computing resource to which the user has requested access is a portion or quantity within the user's permissions, or if the portion of the facility to which the user has requested access is within the one or more specific portions in which the user is permitted. As noted above with respect to the method of FIG. 2, a user's permissions and scope and conditions of those permissions may be set according to the quantitative measure of failure, and thus the comparison of the request to the scope and conditions of the user's permissions functions as a determination if a failure would exceed a threshold set for the user.

The method 500 may further include, at block 510, processing the requested computing action if it is permitted and below the threshold. Block 510 may include, for example, initiating the acquisition on credit, initiating the requested use of a shared computing resource, or granting the user access to the requested facility portion. Instead of block 510, if the requested computing action is either not permitted or exceeds the threshold, the method 500 may including denying the requested computing action.

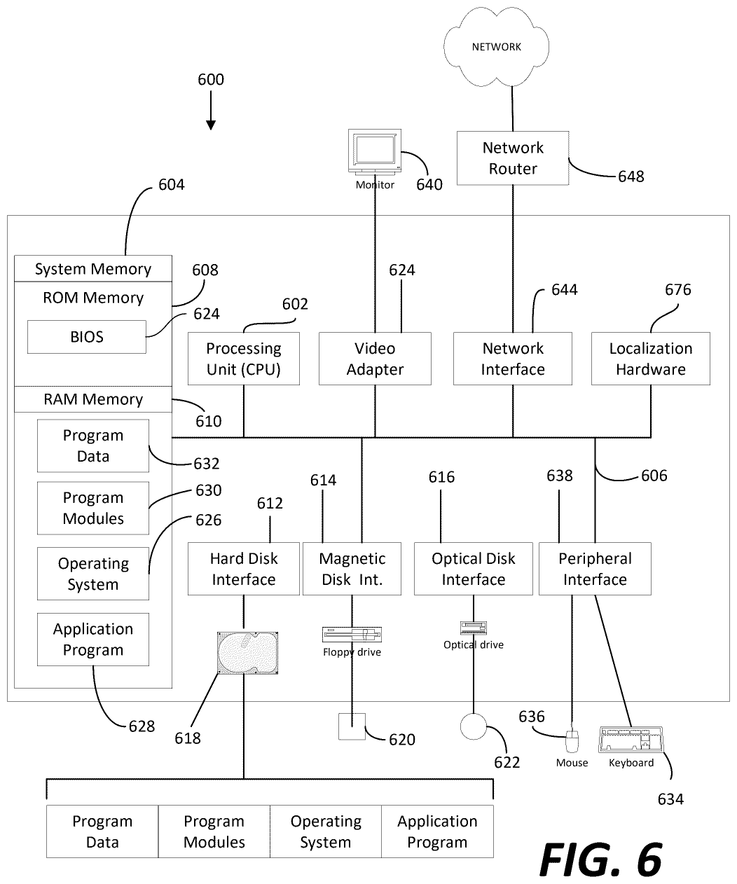

FIG. 6 is a block diagram of an example computing system, such as a desktop computer, laptop, smartphone, tablet, or any other such device having the ability to execute instructions, such as those stored within a non-transient, computer-readable medium. Furthermore, while described and illustrated in the context of a single computing system 600, those skilled in the art will also appreciate that the various tasks described hereinafter may be practiced in a distributed environment having multiple computing systems 600 linked via a local or wide-area network in which the executable instructions may be associated with and/or executed by one or more of multiple computing systems 600.

In its most basic configuration, computing system environment 600 typically includes at least one processing unit 602 and at least one memory 604, which may be linked via a bus 606. Depending on the exact configuration and type of computing system environment, memory 604 may be volatile (such as RAM 610), non-volatile (such as ROM 608, flash memory, etc.) or some combination of the two. Computing system environment 600 may have additional features and/or functionality. For example, computing system environment 600 may also include additional storage (removable and/or non-removable) including, but not limited to, magnetic or optical disks, tape drives and/or flash drives. Such additional memory devices may be made accessible to the computing system environment 600 by means of, for example, a hard disk drive interface 612, a magnetic disk drive interface 614, and/or an optical disk drive interface 616. As will be understood, these devices, which would be linked to the system bus 606, respectively, allow for reading from and writing to a hard disk 618, reading from or writing to a removable magnetic disk 620, and/or for reading from or writing to a removable optical disk 622, such as a CD/DVD ROM or other optical media. The drive interfaces and their associated computer-readable media allow for the nonvolatile storage of computer readable instructions, data structures, program modules and other data for the computing system environment 600. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 600.

A number of program modules may be stored in one or more of the memory/media devices. For example, a basic input/output system (BIOS) 624, containing the basic routines that help to transfer information between elements within the computing system environment 600, such as during start-up, may be stored in ROM 608. Similarly, RAM 610, hard drive 618, and/or peripheral memory devices may be used to store computer executable instructions comprising an operating system 626, one or more applications programs 628, other program modules 630, and/or program data 632. Still further, computer-executable instructions may be downloaded to the computing environment 600 as needed, for example, via a network connection. The applications programs 628 may include, for example, a browser, including a particular browser application and version, which browser application and version may be relevant to determinations of correspondence between communications and user URL requests, as described herein. Similarly, the operating system 626 and its version may be relevant to determinations of correspondence between communications and user URL requests, as described herein.

An end-user may enter commands and information into the computing system environment 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus 606. Input devices may be directly or indirectly connected to processor 602 via interfaces such as, for example, a parallel port, game port, firewire, or a universal serial bus (USB). To view information from the computing system environment 600, a monitor 640 or other type of display device may also be connected to bus 606 via an interface, such as via video adapter 624. In addition to the monitor 640, the computing system environment 600 may also include other peripheral output devices, not shown, such as speakers and printers.

The computing system environment 600 may also utilize logical connections to one or more computing system environments. Communications between the computing system environment 600 and the remote computing system environment may be exchanged via a further processing device, such a network router 648, that is responsible for network routing. Communications with the network router 648 may be performed via a network interface component 644. Thus, within such a networked environment, e.g., the Internet, World Wide Web, LAN, or other like type of wired or wireless network, it will be appreciated that program modules depicted relative to the computing system environment 600, or portions thereof, may be stored in the memory storage device(s) of the computing system environment 600.

The computing system environment 600 may also include localization hardware 646 for determining a location of the computing system environment 600. In embodiments, the localization hardware 646 may include, for example only, a GPS antenna, an RFID chip or reader, a WiFi antenna, or other computing hardware that may be used to capture or transmit signals that may be used to determine the location of the computing system environment 600. Data from the localization hardware 646 may be included in a callback request or other user computing device metadata in the methods of this disclosure.

The computing system 600, or one or more portions thereof, may embody a user computing device 112, in some embodiments. Additionally or alternatively, some components of the computing system 600 may embody the risk classification system 102 and/or transaction processing system 110. For example, the functional modules 120, 122, 124 may be embodied as program modules 630.

In a first aspect of the present disclosure, a computer-implemented method is provided. The method includes receiving, by a computing system, training data respective of a plurality of previous computing actions by a plurality of entities, training, by the computing system, based on the training data, a machine learning model to output a risk score. The training includes use of a loss function having input parameters including a percentage risk that a future computing action will fail, and a quantitative measure of a failed computing action. The method includes receiving, by the computing system, from a user entity, a request for permission to engage in further computing actions, applying, by the computing system, the trained machine learning model to data respective of the user entity to generate a risk score respective of the user entity, and rejecting, by the computing system, based on the risk score, the request for permission.

In an embodiment of the first aspect, the further computing actions would use resources controlled by the computing system. In a further embodiment of the first aspect, the data respective of the user entity includes data respective of computing actions that used resources controlled by the user entity.

In an embodiment of the first aspect, the training data includes first data respective of computing actions engaged in by the plurality of entities and facilitated by the computing system, second data, from a third party, respective of computing actions by the plurality of entities tracked by the third party, and third data respective of bibliographic information of the plurality of entities.

In an embodiment of the first aspect, the data respective of the user entity includes first data respective of computing actions engaged in by the user entity and facilitated by the computing system, second data, from a third party, respective of computing actions by user entity tracked by the third party, and third data respective of bibliographic information of the user entity.

In an embodiment of the first aspect, the loss function determines a logarithm of the quantitative measure.

In an embodiment of the first aspect, the user entity is a first user entity, the request is a first request, the risk score is a first risk score, and the method further includes receiving, by the computing system, from a second user entity, a second request for permission to engage in further computing actions, applying the trained machine learning model to data respective of the second user entity to generate a second risk score respective of the second user entity, and granting, based on the second risk score, the second request for permission, wherein the first user entity is associated with a higher quantitative measure and a lower percentage risk relative to the second user.

In an embodiment of the first aspect, the method further includes defining, based on the second risk score, a scope of further computing actions available to the second user entity.

In a second aspect of the present disclosure, a computing system is provided that includes a processor and a non-transitory, computer-readable medium storing instructions that, when executed by the processor, cause the computing system to perform operations. The operations include receiving training data respective of a plurality of previous computing actions by a plurality of entities, training, based on the training data, a machine learning model to output a risk score, wherein the training comprises use of a loss function having input parameters including a percentage risk that a future computing action will fail and a quantitative measure of a failed computing action, and causing the trained machine learning model to be deployed in order to grant or deny user requests for permission to engage in further computing actions based on data respective of the users.

In an embodiment of the second aspect, the training data includes two or more of first data respective of computing actions facilitated by a computing service to which the trained model is deployed, second data respective of computing actions tracked by a third party, or third data respective of user bibliographic information stored on the computing service.

In an embodiment of the second aspect, the loss function determines a logarithm of the quantitative measure. In a further embodiment of the second aspect, the loss function applies a scaling factor to the logarithm of the quantitative measure.

In a third aspect of the present disclosure, a computer-implemented method is provided that includes receiving, by a first computing system, training data respective of a plurality of previous computing actions by a plurality of first users, training, by the first computing system, based on the training data, a machine learning model to output a risk score. The training includes use of a loss function having input parameters including a percentage risk that a future computing action will fail and a quantitative measure of a failed computing action. The method further includes receiving, by a second computing system, from a second user, a request for permission to engage in further computing actions, applying, by the second computing system, the trained machine learning model to data respective of the second user to generate a risk score respective of the second user, and granting, by the second computing system, based on the risk score, the request for permission.

In an embodiment of the third aspect, the first computing system is the second computing system.

In an embodiment of the third aspect, the method further includes defining, by the second computing system, based on the risk score, a scope of further computing actions available to the second user. In a further embodiment of the third aspect, the scope of further computing actions comprises a maximum quantitative measure of failure for a computing action in which the second user is permitted to engage.

In an embodiment of the third aspect, the training data includes first data respective of computing actions engaged in by the first users via the second computing system, and second data respective of bibliographic information of the first users available to the first computing system.

In an embodiment of the third aspect, the second user is one of the first users.

In an embodiment of the third aspect, the further computing actions would use resources controlled by the second computing system.

In an embodiment of the third aspect, the data respective of the second user includes data respective of computing actions that used resources controlled by the second user.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A computer-implemented method comprising:
receiving, by a computing system, training data respective of a plurality of previous computing actions by a plurality of entities;
training, by the computing system, based on the training data, a machine learning model to output a risk score, wherein the training comprises use of a loss function having input parameters comprising:
a percentage risk that a future computing action will fail; and
a quantitative measure of a failed computing action;
receiving, by the computing system, from a user entity, a request for permission to engage in further computing actions;
applying, by the computing system, the trained machine learning model to data respective of the user entity to generate a risk score respective of the user entity; and
rejecting, by the computing system, based on the risk score, the request for permission.

2. The computer-implemented method of claim 1, wherein the further computing actions would use resources controlled by the computing system.

3. The computer-implemented method of claim 2, wherein the data respective of the user entity comprises data respective of computing actions that used resources controlled by the user entity.

4. The computer-implemented method of claim 1, wherein the training data comprises:
first data respective of computing actions engaged in by the plurality of entities and facilitated by the computing system;
second data, from a third party, respective of computing actions by the plurality of entities tracked by the third party; and
third data respective of bibliographic information of the plurality of entities.

5. The computer-implemented method of claim 1, wherein the data respective of the user entity comprises:
first data respective of computing actions engaged in by the user entity and facilitated by the computing system;
second data, from a third party, respective of computing actions by user entity tracked by the third party; and
third data respective of bibliographic information of the user entity.

6. The computer-implemented method of claim 1, wherein the loss function determines a logarithm of the quantitative measure.

7. The computer-implemented method of claim 1, wherein the user entity is a first user entity, the request is a first request, and the risk score is a first risk score, the method further comprising:
receiving, by the computing system, from a second user entity, a second request for permission to engage in further computing actions;
applying the trained machine learning model to data respective of the second user entity to generate a second risk score respective of the second user entity; and
granting, based on the second risk score, the second request for permission;
wherein the first user entity is associated with a higher quantitative measure and a lower percentage risk relative to the second user.

8. The computer-implemented method of claim 7, further comprising:
defining, based on the second risk score, a scope of further computing actions available to the second user entity.

9. A computing system comprising:
a processor; and
a non-transitory, computer-readable medium storing instructions that, when executed by the processor, cause the computing system to perform operations comprising:
receiving training data respective of a plurality of previous computing actions by a plurality of entities;
training, based on the training data, a machine learning model to output a risk score, wherein the training comprises use of a loss function having input parameters comprising:
a percentage risk that a future computing action will fail; and
a quantitative measure of a failed computing action; and
causing the trained machine learning model to be deployed in order to grant or deny user requests for permission to engage in further computing actions based on data respective of the users.

10. The computing system of claim 9, wherein the training data comprises two or more of:
first data respective of computing actions facilitated by a computing service to which the trained model is deployed;
second data respective of computing actions tracked by a third party; or
third data respective of user bibliographic information stored on the computing service.

11. The computing system of claim 9, wherein the loss function determines a logarithm of the quantitative measure.

12. The computing system of claim 11, wherein the loss function applies a scaling factor to the logarithm of the quantitative measure.

13. A computer-implemented method comprising:
receiving, by a first computing system, training data respective of a plurality of previous computing actions by a plurality of first users;
training, by the first computing system, based on the training data, a machine learning model to output a risk score, wherein the training comprises use of a loss function having input parameters comprising:
a percentage risk that a future computing action will fail; and
a quantitative measure of a failed computing action;
receiving, by a second computing system, from a second user, a request for permission to engage in further computing actions;
applying, by the second computing system, the trained machine learning model to data respective of the second user to generate a risk score respective of the second user; and
granting, by the second computing system, based on the risk score, the request for permission.

14. The computer-implemented method of claim 13, wherein the first computing system is the second computing system.

15. The computer-implemented method of claim 13, further comprising:
defining, by the second computing system, based on the risk score, a scope of further computing actions available to the second user.

16. The computer-implemented method of claim 15, wherein the scope of further computing actions comprises a maximum quantitative measure of failure for a computing action in which the second user is permitted to engage.

17. The computer-implemented method of claim 13, wherein the training data comprises:
first data respective of computing actions engaged in by the first users via the second computing system; and
second data respective of bibliographic information of the first users available to the first computing system.

18. The computer-implemented method of claim 13, wherein the second user is one of the first users.

19. The computer-implemented method of claim 13, wherein the further computing actions would use resources controlled by the second computing system.

20. The computer-implemented method of claim 13, wherein the data respective of the second user comprises data respective of computing actions that used resources controlled by the second user.
